(19) United States
(12) Patent Application Publication
(10) Pub. No.: US 2025/0005441 A1
(43) Pub. Date: Jan. 2, 2025

(54) System and method for training an artificial intelligent system based on entity rules, regulation rules, and core values

(71) Applicant: Bank of America Corporation, Charlotte, NC (US)

(72) Inventor: Vijay Kumar Yarabolu, Hyderabad (IN)

(21) Appl. No.: 18/343,836

(22) Filed: Jun. 29, 2023

(51) Int. Cl. G06N 20/00

(52) U.S. Cl. CPC G06N 20/00

(57) ABSTRACT

A system for training an artificial intelligence system based on entity rules, regulation rules, and core values comprises a processor associated with a server. The processor analyzes a first set of data objects associated with a first set of data groups to derive a set of logic relationships between the first set of the data objects. The processor trains a machine learning model with the first set of the data objects and the logic relationships based on a set of training rules to meet one or more entity rules with a desired accuracy. The processor tests the machine learning model with the first set of the data objects and the set of the logic relationships. The processor retrains the tested machine learning model with a second set of data objects to meet the one or more regulation rules and the one or more core values.

### TECHNICAL FIELD

The present disclosure relates generally to network communications and information security, and more specifically to a system and method for training artificial intelligence systems based on entity rules, regulation rules, and core values.

### BACKGROUND

An autonomous intelligence system may gradually learn and evolve undesired results over time if no particular monitoring process is applied. Current technologies are not configured to provide a reliable and efficient solution to monitor the autonomous intelligence system and reduce or avoid undesirable evolution.

### SUMMARY

Current technology is not configured to provide a reliable and efficient solution to keep an artificial intelligence system from evolving beyond particular rules and core values. The system described in the present disclosure is particularly integrated into a practical application and provides technical solutions to train artificial intelligence systems based on entity rules, regulation rules, and core values in a network.

In a conventional system, an artificial intelligence system (e.g., a machine learning model) may learn, evolve and act independently in real time. Over time, the machine learning model may gradually evolve beyond certain rules and core values even though it still satisfies some other rules. Currently there is no mechanism that monitors the machine learning model and reduces or avoids undesirable evolution with respect to entity rules, regulation rules, and core values.

In one embodiment, the system for training an artificial intelligence system based on entity rules, regulation rules, and core values in a network comprises a processor and a memory. The memory may be operable to store a plurality of data groups including a plurality of data objects, a plurality of entity rules, a plurality of regulation rules, and one or more core values. The processor analyzes a first set of data objects associated with a first set of data groups to derive a set of logic relationships between the first set of the data objects. The processor trains a machine learning model with the first set of the data objects and the set of the logic relationships based on a set of training rules. The processor determines whether the machine learning model is trained to meet one or more entity rules with a desired accuracy. In response to determining that the machine learning model meets one or more entity rules with the desired accuracy, the processor tests the machine learning model with the first set of the data objects and the set of the logic relationships. The processor determines whether the tested machine learning model meets one or more regulation rules and one or more core values. In response to determining that the tested machine learning model does not meet the one or more regulation rules or the one or more core values, the processor refines one or more training rules to generate a second set of data objects associated with a second set of data groups. The processor retrains the machine learning model with the second set of the data objects to meet the one or more regulation rules and the one or more core values.

The system described in the present disclosure provides technical solutions to solve the technical problems of the previous systems. For example, the trained machine learning model may be integrated into a software application executed by a central server to analyze a first set of data objects associated with different data groups to derive logic relationships between the data objects. Further the trained machine learning model is tested with respect to particular regulation rules and core values. When the tested machine learning model does not meet the particular regulation rules and core values, the system may refine training rules to generate a second set of data objects to retrain the machine learning model to meet the entity rules, the regulation rules, and the core values. Thus, the system may effectively monitor the machine learning model and prevent it from developing undesirable results, such as vulnerable logic relationships between the data objects in the network in real time.

As such, the disclosed system may prevent threat scenarios associated with the vulnerable logic relationships between the data objects in a computer network. By reducing or avoiding these threat scenarios, the computer system can reduce unnecessary increases in the number of network resources and bandwidth that are consumed that would otherwise negatively impact on information security of an organization entity and the throughput of the computer system. Accordingly, the disclosed system may be integrated into a practical application of using artificial intelligence systems more efficiently and reducing the likelihood that artificial intelligence systems evolve using vulnerable or incomplete data.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to train a machine learning model based on entity rules, regulation rules, and core values; and

FIG. 2 illustrates an example operational flow of a method for training the machine learning model based on the entity rules, the regulation rules, and the core values.

### DETAILED DESCRIPTION

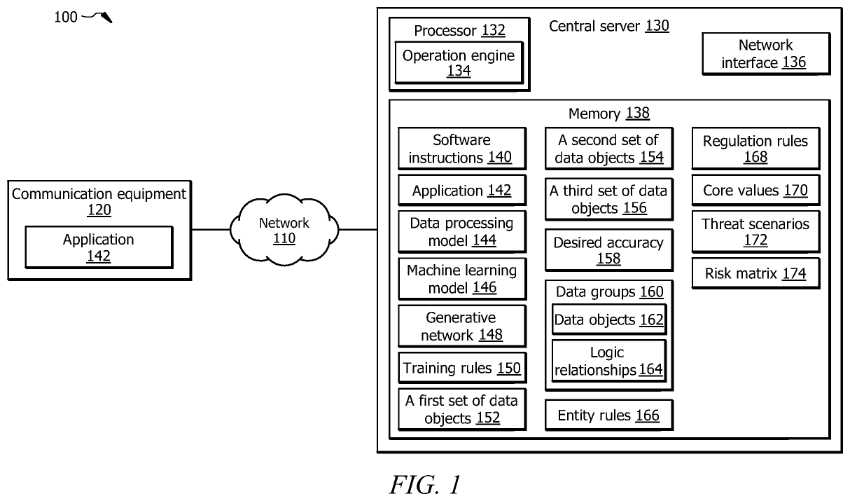

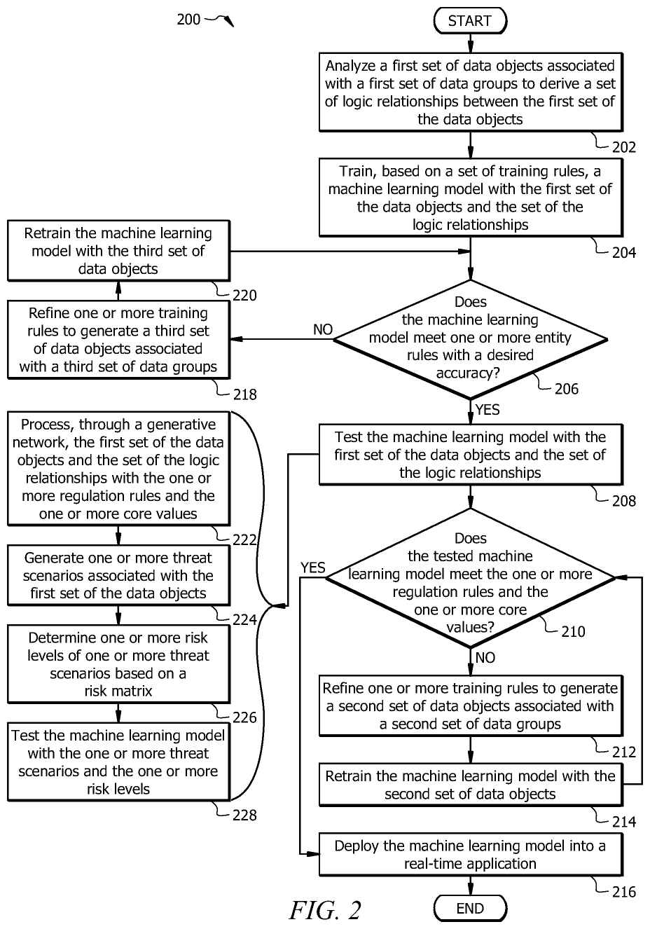

Previous technologies fail to provide efficient and reliable solutions to prevent a machine learning model from evolving beyond rules and core values. This disclosure presents a system for training the machine learning model based on entity rules, regulation rules, and core values by referring to FIGS. 1-2.

### Example System for Predicting Anomalous Interactions in a Network

FIG. 1 illustrates one embodiment of a system 100 that is configured to train a machine learning model 144 based on entity rules, regulation rules, and core values in a network 110. In one embodiment, system 100 comprises a central server 130, one or more communication equipment 120, and a network 110. Network 110 enables the communication between components of the system 100. As illustrated in FIG. 1, the central server 130 comprises a processor 132 in signal communication with a memory 138. Memory 138 stores software instructions 140 that when executed by the processor 132, cause the processor 132 to execute one or more functions described herein. In other embodiments, system 100 may not have all the components listed and/or may have other elements instead of, or in addition to, those listed above.

In general, an organization entity may provide certain application services through the central server 130 based on particular entity rules (e.g., entity operation goals and standards), organization rules (e.g., local laws and regulations), and core values (e.g., entity service scores or values), etc. The central server 130 may use a machine learning model 146 to process a data group 160 of data objects 162 associated with an application service to determine whether the data objects 162 and corresponding logic relationships 164 between the data objects 162 meet the entity rules, the organization rules, and the core values before approving a service request. In some embodiment, the central server 130 may use a plurality of historical data groups 160 of data objects 162 to train a machine learning model 146 to meet entity rules 166, regulation rules 168, and core values 170 which are stored in the memory 138. For example, the central server 130 may analyze a first set of data objects 152 associated with a first set of data groups 160 to derive a set of logic relationships 164 between the first set of the data objects 152. The central server 130 may train the machine learning model 146 with the first set of the data objects 152 and the set of the logic relationships 164 based on a set of training rules 150. The central server 130 may determine that the machine learning model 146 is trained to meet one or more entity rules 166 with a desired accuracy 158. The central server 130 may test the machine learning model 146 with the first set of the data objects 152 and the set of the logic relationships 164. The central server 130 may determine whether the tested machine learning model 146 meets one or more regulation rules 168 and one or more core values 170. When it is determined that the tested machine learning model 146 does not meet the one or more regulation rules 168 or the one or more core values 170, the central server 130 may refine one or more training rules 150 to generate a second set of data objects 154. The central server 130 may retrain the machine learning model 146 with the second set of the data objects 154 to meet the one or more regulation rules 168 and the one or more core values 170.

### System Components

### Network

Network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Communication Equipment

Communication equipment 120 is generally any device that is configured to communicate with the central server 130. Examples of the communication equipment 120 include, but are not limited to, a personal computer, a desktop computer, a workstation, a server, a laptop, a tablet computer, a mobile phone (such as a smartphone), etc. The communication equipment 120 may include a user interface, such as a display, a microphone, keypad, or other appropriate terminal equipment usable by user. The communication equipment 120 may include a hardware processor, memory, and/or circuitry configured to perform any of the functions or actions of the communication equipment 120 described herein. The hardware processor may include one or more processors operably coupled to the memory. The one or more processors may be any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The one or more processors may be a programmable logic device, a microcontroller, a microprocessor, or any suitable combination of the preceding. The one or more processors are configured to process data and may be implemented in hardware or software. For example, the processor may be 8-bit, 16-bit, 32-bit, 64-bit, or of any other suitable architecture. The processor may include an arithmetic logic unit (ALU) for performing arithmetic and logic operations. For example, a software application designed using software code may be stored in the memory and executed by the processor to perform the functions of the communication equipment 120.

The communication equipment 120 stores and/or includes the application 142. The application 142 may be a software, mobile, or web application. The application 142 may be associated with an organization entity that provides services and/or products to users. Application 142 may be generally configured to receive a plurality of data groups 160 of data objects 162 from the users associated with the communication equipment.

### Central Server

Central server 130 is generally a server, or any other device configured to process data and communicate with communication equipment 120 via the network 110. The central server 130 is generally configured to oversee the operations of the operation engine 134, as described further below in conjunction with the operational flows of the method 200 described in FIG. 2. The central server 130 may be a server implemented in the cloud and may also be organized in a distributed manner.

Processor 132 comprises one or more processors operably coupled to the memory 138. The processor 132 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 132 may be a programmable logic device, a microcontroller, a microprocessor, or any suitable combination of the preceding. The one or more processors are configured to process data and may be implemented in hardware or software. For example, the processor 132 may be 8-bit, 16-bit, 32-bit, 64-bit, or of any other suitable architecture. The processor 132 may include an arithmetic logic unit (ALU) for performing arithmetic and logic operations. The processor 132 registers the supply operands to the ALU and stores the results of ALU operations. The processor 132 is a control unit that fetches instructions from memory and executes them by directing the coordinated operations of the ALU, registers and other components. The one or more processors are configured to implement various instructions. For example, the one or more processors are configured to execute instructions (e.g., software instructions 140) to implement the operation engine 134. In this way, the processor 132 may be a special-purpose computer designed to implement the functions disclosed herein. In one embodiment, the processor 132 is implemented using logic units, FPGAs, ASICs, DSPs, or any other suitable hardware. The processor 132 is configured to operate to perform one or more operations as described in FIG. 2.

Network interface 136 is configured to enable wired and/or wireless communications (e.g., via network 110). The network interface 136 is configured to communicate data between the central server 130 and other devices (e.g., communication equipment 120), databases, systems, or domains. For example, the network interface 136 may comprise a WIFI interface, a local area network (LAN) interface, a wide area network (WAN) interface, a modem, a switch, or a router. The processor 132 is configured to send and receive data using the network interface 136. The network interface 136 may be configured to use any suitable type of communication protocol as would be appreciated by one of ordinary skill in the art.

Memory 138 may be volatile or non-volatile and may comprise a read-only memory (ROM), random-access memory (RAM), ternary content-addressable memory (TCAM), dynamic random-access memory (DRAM), and static random-access memory (SRAM). Memory 138 may be a non-transitory computer-readable medium implemented using one or more disks, tape drives, solid-state drives, and/or the like. Memory 138 is operable to store the software instructions 140, data groups 160 including data objects 152 and logic relationships 164, entity rules 166, regulation rules 168, core values 170, threat scenarios 172, risk matrix 174, training rules 150, a first set of data objects 152, a second set of data objects 154, a third set of data objects 156, a desired accuracy 158, and/or any other data or instructions. The software instructions 140 may store any suitable set of instructions, logic, rules, or code operable to be executed by the processor 132 to implement the processes and embodiments described below. In an example operation, the memory 138 may store a user interface application 142, a data processing model 144, a machine learning model 146, a generative network 148, and other program modules which are implemented in computer-executable software instructions. The machine learning model 146 may include one or more learning algorithms including support vector machine, neural network, random forest, k-means clustering, etc. The generative network 148 may be implemented by a plurality of neural network (NN) layers, convolutional NN (CNN) layers, Long-Short-Term-Memory (LSTM) layers, Bi-directional LSTM layers, Recurrent NN (RNN) layers, and the like.

### Operation Engine

Operation engine 134 may include, but is not limited to, one or more separate and independent software and/or hardware components of a central server 130. In some embodiments, the operation engine 134 may be implemented by the processor 132 by executing the software instructions 140 to analyze a set of data objects 162 to derive corresponding logic relationships 164 between the data objects 162. The operation engine 134 may be implemented by the processor 132 by executing the software instructions 140 to train a machine learning model 146 with the data objects 162 and the corresponding logic relationships 164 to meet one or more entity rules 166 with a desired accuracy 158. The operation engine 134 may be implemented by the processor 132 by executing the software instructions 140 to test and retrain the machine learning model 146 to meet one or more regulation rules 168 and one or more core values 170. The operation of the system 100 is described in FIG. 2 below.

### Analyzing Data Objects to Derive Logic Relationships Between the Data Objects

In some embodiments, the central server 130 may interact with communication equipment 120 to receive a plurality of data groups 160 associated with one or more entity services. The central server 130 may access other data sources to retrieve a plurality of data groups 160. The data objects 162 may be generated by the central server 130 based on the plurality of the data groups 160 which may include documents and media items with natural language text elements, codes, etc. For example, a data group 160 of data objects 162 may represent a set of data features or attributes associated with a user or an application service. A set of data objects 162 may include a user identity, interaction data objects, data objects 162 associated with entity rules 166, data objects 162 associated with regulation rules 168, data objects 162 associated with core values 170, etc. The central server 130 may analyze a plurality of data groups 160 and derive a set of logic relationships 164 between the data objects 162 of each data group 160. In one embodiment, the logic relationship 164 between a group of data objects 162 may represent textual relationships between different textual objects. The logic relationship 164 between the data objects 162 may represent a description related to an entity rule 166, a regulation rule 168 or a core value 170 associated with the application service. For example, a user with a particular citizenship is allowed to have a benefit provided by the application service based on an entity rule 166. A user living in a particular area is required to have an evaluation score or pay a particular fee to be eligible to apply for an application service based on a core value associated with the application service. The machine learning model 146 may be trained with historical data objects 162 and the logic relationship 164 between the data objects 162 to meet certain entity rules 166, regulation rules 168 and core values 170 required by the entity services.

### Training a Machine Learning Model to Meet Entity Rules

The central server 130 may generate a first set of data objects 152 associated with a first set of data groups 160 from a plurality of data groups 160. The central server 130 may derive a set of logic relationships 164 between the first set of the data objects 152. The central server 130 may train the machine learning model 146 to learn the entity rules 166 with the first set of the data objects 152 and the logic relationships 164 between corresponding data objects 152. The machine learning model 146 may be trained to meet one or more entity rules 166 with a desired accuracy 158. The desired accuracy 158 represents a threshold of an accuracy measure at which the logic relationships 164 between corresponding data objects 152 satisfy the entity rules 166 associated with the entity service. For example, the machine learning model 146 may be trained to generate an accuracy measure of the logic relationships 164 with respect to the entity rules 166. The central server 130 may determine whether the accuracy measure of the machine learning model 146 is higher than the desired accuracy 158 to meet the entity rules 166. When the accuracy measure of the machine learning model 146 is higher than the desired accuracy 158, the central server 130 may further test the machine learning model 146 and retrain the tested machine learning model 146 with a second set of data objects 154 to meet one or more regulation rules 168 and one or more core values 170.

When the accuracy measure of the machine learning model 146 is not higher than the desired accuracy 158, the central server 130 may determine that the machine learning model 146 does not meet one or more entity rules 166 with the desired accuracy 158. The central server 130 may refine one or more training rules 150 to generate a third set of data objects 156 associated with a third set of data groups 160. The central server 130 may retrain the machine learning model 146 with the third set of the data objects 156 to meet the entity rules 166 with the desired accuracy 158.

In some embodiments, the central server 130 may execute the software instructions 140 to refine one or more training rules 150 to generate a new set of the data objects 162. In some embodiments, refining the one or more training rules 150 comprises applying different data engineering rules, improving sampling rules, or adjusting one or more hyper parameters. Applying different data engineering rules for training the machine learning model 146 may include collecting additional historical data groups of data objects. Collecting additional historical data may include collecting augmented data or rescaling the historical data associated with the plurality of the data groups 160. Improving sampling rules for training the machine learning model 146 may include applying the sampling rules on the data objects 162. The sampling rules may include stratified sampling, cluster sampling, random sampling, etc. Adjusting one or more hyper parameters for training the machine learning model 146 may include adjusting learning rates, value of bias, input weights, a number of hidden layers, a number of clusters, etc.

### Test and Retrain the Machine Learning Model to Meet Regulation Rules and Core Values

After the machine learning model 146 is trained to meet one or more entity rules 166 with a desired accuracy 158, the central server 130 may test the machine learning model 146 with the first set of the data objects 152 and the set of the logic relationships 164 with respect to one or more regulation rules 168 and one or more core values 170. The central server 130 may determine whether the tested machine learning model 146 meets one or more regulation rules 168 and one or more core values 170. In some embodiments, the central server 130 may process, through a generative network 148, the first set of the data objects 152 with the set of the logic relationships 164 to generate one or more threat scenarios associated with the first set of the data objects. The generative network 148 may be trained with historical data objects which are accepted and used in one or more interactions associated with the entity services. The historical data objects may satisfy one or more regulation rules 168 and one or more core values 170 required by the entity services. The one or more threat scenarios 172 may include one or more logic relationships 164 which may be vulnerable and do not meet the one or more regulation rules 168 or the one or more core values 170 required by the entity services.

In one embodiment, the central server 130 may analyze the one or more threat scenarios 172 with a risk matrix 174 to determine the one or more corresponding risk levels. An example risk matrix 174 may include a set of values each associated with a likelihood and an impact of the one or more data objects which may be vulnerable to the entity services. The central server 130 may test the machine learning model 146 with the one or more threat scenarios 172 and the one or more corresponding risk levels to determine whether the first set of the data objects 152 meets the one or more regulation rules 168 or the one or more core values 170. When the central server 130 determines that the tested machine learning model 146 does not meet the one or more regulation rules 168 or the one or more core values 170, the central server 130 may refine one or more training rules 150 to generate a second set of data objects 154 associated with a second set of data groups 160. The central server 130 may retrain the machine learning model 146 with the second set of the data objects 154 to meet the one or more regulation rules 168 and the one or more core values 170. The process is described in detail in conjunction with the operational flows of the methods 200 illustrated in FIG. 2.

### Example Operational Flow for Training Artificial Intelligence Systems Based on Entity Rules, Regulation Rules, and Core Values

FIG. 2 illustrates an example flow of a method 200 for training an artificial intelligence system such as a machine learning model 146 based on entity rules 166, regulation rules 168, and core values 170 in the system 100. Modifications, additions, or omissions may be made to method 200. Method 200 may include more, fewer, or other operations. For example, operations may be performed by the central server 130 in parallel or in any suitable order. While at times discussed as the system 100, processor 132, operation engine 134, data processing model 144, machine learning model 146, or components of any of thereof performing operations, any suitable system or components of the system may perform one or more operations of the method 200. For example, one or more operations of method 200 may be implemented, at least in part, in the form of software instructions 140 of FIG. 1, stored on non-transitory, tangible, computer-readable media (e.g., memory 138 of FIG. 1) that when run by one or more processors (e.g., processor 132 of FIG. 1) may cause the one or more processors to perform operations 202-228.

The method 200 begins at operation 202 where the processor 132 executes the operation engine 134 to analyze a first set of data objects 152 associated with a first set of data groups 160 to derive a set of logic relationships 164 between the first set of the data objects 152.

At operation 204, the central server 130 may train, based on a set of training rules 150, a machine learning model 146 with the first set of the data objects 152 and the set of the logic relationships 164.

At operation 206, the central server 130 may determine whether the machine learning model 146 is trained to meet one or more entity rules 166 with a desired accuracy 158. At operation 218, in response to determining that the machine learning model 146 does not meet one or more entity rules 166 with the desired accuracy 158, the central server 130 may refine one or more training rules 150 to generate a third set of data objects 156 associated with a third set of data groups 160. At operation 220, the central server 130 may retrain the machine learning model 146 with the third set of the data objects 156 to meet the one or more entity rules 166 with the desired accuracy 158.

At operation 208, in response to determining that the machine learning model 146 meets the one or more entity rules 166 with the desired accuracy 158, the central server 130 may test the machine learning model 146 with the first set of the data objects 152 and the set of the logic relationships 164 with respect to one or more regulation rules 168 and one or more core values 170.

At operation 210, the central server 130 may determine whether the tested machine learning model 146 meets one or more regulation rules 168 and one or more core values 170.

At operation 212, in response to determining that the tested machine learning model 146 does not meet the one or more regulation rules or the one or more core values, the central server 130 may refine one or more training rules 150 to generate a second set of data objects 154 associated with a second set of data groups 160.

At operation 214, the central server 130 may retrain the machine learning model 146 with the second set of the data objects 154 to meet the one or more regulation rules 168 and the one or more core values 170. The retraining process of the operations 212-214 may be performed by the central server 130 until that the machine learning model 146 meets the one or more regulation rules or the one or more core values at the operation 210.

At operation 216, in response to determining that the machine learning model 146 meets the one or more regulation rules 168 and the one or more core values 170, the central server 130 may deploy the machine learning model 146 into a real-time application.

In some embodiments, referring back to the operation 208, the central server 130 may perform operations 222-228 to test the machine learning model 146 with the first set of the data objects 152 and the set of the logic relationships 164 with respect to the one or more regulation rules 168 and the one or more core values 170.

At operation 222, the central server 130 may process, through a generative network 148, the first set of the data objects 152 and the set of the logic relationships 164 with the one or more regulation rules 168 and the one or more core values 170.

At operation 224, the central server 130 may generate one or more threat scenarios 172 associated with the first set of the data objects 152. The one or more threat scenarios 172 may include one or more vulnerable data objects 162 which do not meet the one or more regulation rules 168 and the one or more core values 170. The logic relationships 164 associated with the one or more vulnerable data objects 162 may be vulnerable to the entity services provided by the origination entity.

At operation 226, the central server 130 may determine one or more risk levels of the one or more threat scenarios 172 based on a risk matrix 174.

At operation 228, the central server 130 may test the machine learning model 146 with the one or more threat scenarios 172 and the one or more risk levels to determine whether the first set of the data objects 152 meets the one or more regulation rules 168 and the one or more core values 170.

The disclosed system is integrated into a practical application and may effectively prevent a machine learning model 146 from evolving vulnerable logic relationships 164 between the data objects 162. Accordingly, the machine learning model 146 may continuously learn, evolve and act to meet entity rules, regulation rules, and core values required by the entity services in real time.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system comprising:
a memory operable to store:
a plurality of data groups comprising a plurality of data objects;
a plurality of entity rules;
a plurality of regulation rules; and
one or more core values; and
a processor operably coupled to the memory, the processor configured to:
analyze a first set of data objects associated with a first set of data groups to derive a set of logic relationships between the first set of the data objects;
train, based on a set of training rules, a machine learning model with the first set of the data objects and the set of the logic relationships;
determine whether the machine learning model is trained to meet one or more entity rules with a desired accuracy;
in response to determining that the machine learning model meets one or more entity rules with the desired accuracy, test the machine learning model with the first set of the data objects and the set of the logic relationships;
determine whether the tested machine learning model meets one or more regulation rules and one or more core values;
in response to determining that the tested machine learning model does not meet the one or more regulation rules or the one or more core values, refine one or more training rules to generate a second set of data objects associated with a second set of data groups; and
retrain the machine learning model with the second set of the data objects to meet the one or more regulation rules and the one or more core values.

2. The system of claim 1, wherein the processor is further configured to:
determine that the tested machine learning model meets the one or more regulation rules and the one or more core values; and
deploy the machine learning model into a real-time application.

3. The system of claim 1, wherein the processor is further configured to:
in response to determining that the machine learning model does not meet one or more entity rules with the desired accuracy, refine one or more training rules to generate a third set of data objects associated with a third set of data groups; and
retrain the machine learning model with the third set of the data objects to meet the one or more entity rules with the desired accuracy.

4. The system of claim 1, wherein the processor is further configured to:
process, through a generative network, the first set of the data objects and the set of the logic relationships with the one or more regulation rules and the one or more core values;
generate one or more threat scenarios associated with the first set of the data objects, wherein the one or more threat scenarios may include one or more vulnerable data objects in the first set of the data objects;
determine one or more risk levels of the one or more threat scenarios based on a risk matrix; and
test the machine learning model with the one or more threat scenarios and the one or more risk levels to determine whether the first set of the data objects meets the one or more regulation rules and the one or more core values.

5. The system of claim 1, wherein refining the one or more training rules comprises adjusting one or more hyper parameters, improving sampling rules, or collecting additional historical data.

6. The system of claim 5, wherein the sampling rules comprise stratified sampling, cluster sampling or random sampling.

7. The system of claim 5, wherein collecting the additional historical data comprises collecting augmented data or rescaling the historical data associated with the plurality of the data groups.

8. A method comprising:
analyzing a first set of data objects associated with a first set of data groups to derive a set of logic relationships between the first set of the data objects;
training, based on a set of training rules, a machine learning model with the first set of the data objects and the set of the logic relationships;
determining whether the machine learning model is trained to meet one or more entity rules with a desired accuracy;
in response to determining that the machine learning model meets one or more entity rules with the desired accuracy, testing the machine learning model with the first set of the data objects and the set of the logic relationships;
determining whether the tested machine learning model meets one or more regulation rules and one or more core values;
in response to determining that the tested machine learning model does not meet the one or more regulation rules or the one or more core values, refining one or more training rules to generate a second set of data objects associated with a second set of data groups; and
retraining the machine learning model with the second set of the data objects to meet the one or more regulation rules and the one or more core values.

9. The method of claim 8, further comprising:
determining that the tested machine learning model meets the one or more regulation rules and the one or more core values; and
deploying the machine learning model into a real-time application.

10. The method of claim 8, further comprising:
in response to determining that the machine learning model does not meet one or more entity rules with the desired accuracy, refining one or more training rules to generate a third set of data objects associated with a third set of data groups; and
retraining the machine learning model with the third set of the data objects to meet the one or more entity rules with the desired accuracy.

11. The method of claim 8, further comprising:
processing, through a generative network, the first set of the data objects and the set of the logic relationships with the one or more regulation rules and the one or more core values;
generating one or more threat scenarios associated with the first set of the data objects, wherein the one or more threat scenarios may include one or more vulnerable data objects in the first set of the data objects;
determining one or more risk levels of the one or more threat scenarios based on a risk matrix; and
testing the machine learning model with the one or more threat scenarios and the one or more risk levels to determine whether the first set of the data objects meets the one or more regulation rules and the one or more core values.

12. The method of claim 8, wherein refining the one or more training rules comprises adjusting one or more hyper parameters, improving sampling rules, or collecting additional historical data.

13. The method of claim 12, wherein the sampling rules comprise stratified sampling, cluster sampling or random sampling.

14. The method of claim 12, wherein collecting the additional historical data comprises collecting augmented data or rescaling the historical data associated with a plurality of data groups.

15. A non-transitory computer-readable medium storing instructions that when executed by a processor causes the processor to:
analyze a first set of data objects associated with a first set of data groups to derive a set of logic relationships between the first set of the data objects;
train, based on a set of training rules, a machine learning model with the first set of the data objects and the set of the logic relationships;
determine whether the machine learning model is trained to meet one or more entity rules with a desired accuracy;
in response to determining that the machine learning model meets one or more entity rules with the desired accuracy, test the machine learning model with the first set of the data objects and the set of the logic relationships;
determine whether the tested machine learning model meets one or more regulation rules and one or more core values;
in response to determining that the tested machine learning model does not meet the one or more regulation rules or the one or more core values, refine one or more training rules to generate a second set of data objects associated with a second set of data groups; and
retrain the machine learning model with the second set of the data objects to meet the one or more regulation rules and the one or more core values.

16. The non-transitory computer-readable medium of claim 15, wherein the instructions when executed by the processor further cause the processor to:
determine that the tested machine learning model meets the one or more regulation rules and the one or more core values; and
deploy the machine learning model into a real-time application.

17. The non-transitory computer-readable medium of claim 15, wherein the instructions when executed by the processor further cause the processor to:
in response to determining that the machine learning model does not meet one or more entity rules with the desired accuracy, refine one or more training rules to generate a third set of data objects associated with a third set of data groups; and
retrain the machine learning model with the third set of the data objects to meet the one or more entity rules with the desired accuracy.

18. The non-transitory computer-readable medium of claim 15, wherein the instructions when executed by the processor further cause the processor to:
process, through a generative network, the first set of the data objects and the set of the logic relationships with the one or more regulation rules and the one or more core values;
generate one or more threat scenarios associated with the first set of the data objects, wherein the one or more threat scenarios may include one or more vulnerable data objects in the first set of the data objects;
determine one or more risk levels of the one or more threat scenarios based on a risk matrix; and
test the machine learning model with the one or more threat scenarios and the one or more risk levels to determine whether the first set of the data objects meets the one or more regulation rules and the one or more core values.

19. The non-transitory computer-readable medium of claim 15, wherein refining the one or more training rules comprises adjusting one or more hyper parameters, improving sampling rules, or collecting additional historical data.

20. The non-transitory computer-readable medium of claim 19, wherein the sampling rules comprise stratified sampling, cluster sampling or random sampling; and wherein collecting the additional historical data comprises collecting augmented data or rescaling the historical data associated with a plurality of data groups.
